(19) United States
(12) Patent Application Publication
(10) Pub. No.: US 2012/0222804 A1
(43) Pub. Date: Sep. 6, 2012

(54) IMAGE TRANSFER SHEET WITH LASER, LED, OR DYE-SUBLIMINATION PRINTED IMAGE AND METHODS OF MAKING AND USING

(76) Inventor: Kangning Liang, Bartlett, TN (US)

(21) Appl. No.: 13/041,290

(22) Filed: Mar. 4, 2011

(51) Int. Cl. B44C 1/175; B32B 3/10; B32B 7/06; B41J 2/435

(52) U.S. Cl. 156/230; 347/224; 428/202; 428/40.1; 428/195.1

(57) ABSTRACT

An multilayer image transfer sheet for non-thermally transferring an image to a receiving object includes, in the following order with respect to each other, a backing sheet; a water-releasable sacrificial layer disposed on the backing sheet; a printed image layer disposed over the water-releasable sacrificial layer; and an adhesive layer disposed over the printed image layer and configured and arranged for permanent attachment of the printed image layer to a receiving object. The printed image layer comprises toner or dye printed using a laser printer, LED printer, or dye-sublimation printer.

### FIELD

The invention is directed to an image transfer sheet and method of making and using the image transfer sheet. The invention is also directed to an image transfer sheet with one or more sacrificial layers and a printed image (e.g., using a laser printer, LED printer, or dye-sublimation printer) and methods of making and using the image transfer sheet.

### BACKGROUND

There are many ways to decorate objects such as garments, mugs, and the like with a graphical image. For example, an image can be either directly printed on a garment using a specialized inkjet printer or a screen printing technique, or by first printing the image on a thermoplastic film and subsequently attaching it to a garment through an iron-on process at substantially elevated temperatures. However, these methods have some of the drawbacks including expensive specialty printing equipment and materials, tedious processes unsuitable to hobbyists and general consumers, safety concerns with using hot irons, limited applications, and heavy preparations. There is a need for an image transfer method that allows creating an image on an object with one or more advantages such as low cost, high quality, high versatility, consumer-friendliness, convenience, or safety.

### BRIEF SUMMARY

One embodiment is a multilayer image transfer sheet for non-thermally transferring an image to a receiving object. The image transfer sheet includes, in the following order with respect to each other, a backing sheet; a water-releasable sacrificial layer disposed on the backing sheet; a printed image layer disposed over the water-releasable sacrificial layer; and an adhesive layer disposed over the printed image layer and configured and arranged for permanent attachment of the printed image layer to a receiving object. The printed image layer comprises toner or dye printed using a laser printer, LED printer, or dye-sublimation printer to form at least one image.

Another embodiment is a method for non-thermal transfer of an image onto an article that includes providing the multilayer image transfer sheet of describe above; permanently attaching the multilayer image transfer sheet to the article using the adhesive layer; removing the backing sheet; and removing the water-releasable sacrificial layer by exposure to water.

A further embodiment is a method of making a multilayer image transfer sheet that includes forming a water-releasable sacrificial layer on a backing sheet; printing an image layer over the water-releasable sacrificial layer using a laser printer, LED printer, or dye-sublimation printer; and disposing an adhesive layer over the image layer. The adhesive layer is configured and arranged for permanent attachment of the printed image layer to a receiving object.

Yet another embodiment is a sheet for non-thermally transferring an image to a receiving object. The sheet includes, in the following order with respect to each other, a backing sheet; a water-releasable sacrificial layer disposed on the release liner; and an image receiving layer configured and arranged to receive an image printed using a laser printer, LED printer, or dye-sublimation printer onto the image receiving layer.

A further embodiment is a kit for non-thermally transferring an image to a receiving object that includes the sheet described immediately above and adhesive configured and arranged for application over an image printed on the image receiving layer and for permanent attachment of the sheet and image to a receiving object.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIGS. 1A-1F illustrate steps in one embodiment of a process for the transfer of an image to a receiving object using an image transfer sheet, according to the invention;

FIGS. 2A-2E illustrate steps in a second embodiment of a process for the transfer of an image to a receiving object using an image transfer sheet, according to the invention;

FIGS. 3A-3E illustrate steps in a third embodiment of a process for the transfer of an image to a receiving object using an image transfer sheet, according to the invention;

FIGS. 4A-4E illustrate steps in a fourth embodiment of a process for the transfer of an image to a receiving object using an image transfer sheet, according to the invention; and

FIGS. 5A-5E illustrate steps in a fifth embodiment of a process for the transfer of an image to a receiving object using an image transfer sheet, according to the invention.

### DETAILED DESCRIPTION

The invention is directed to an image transfer sheet and method of making and using the image transfer sheet. The invention is also directed to an image transfer sheet with one or more sacrificial layers and a printed image (e.g., using a laser printer, LED printer, or dye-sublimation printer) and methods of making and using the image transfer sheet.

An image transfer sheet includes a sacrificial layer onto, or over, which an image can be printed. In at least some embodiments, the image can be printed using conventional laser printers. LED printers, or dye-sublimation printers found in offices and households. Although the present description is generally directed to printing an image on the image transfer sheet using a laser printer, LED printer, or dye-sublimation printer, it will be recognized that other types of printers may also be used for forming the image on the image transfer sheet. The image thus formed on the image transfer sheet can be transferred to the surface of a receiving object with the help of an adhesive. This transfer of the image to the receiving object is preferably a non-thermal transfer process. The sacrificial layer is eventually removed with the help of an appropriate solvent, such as water, resulting in an image bonded to the object. Other image transfer sheets are described in U.S. patent application Ser. No. ______, Attorney Docket No. 135402-2038, filed on even date herewith and incorporated herein by reference. These other image transfer sheets may be particularly useful for images formed using inkjet printers.

As used herein and unless otherwise indicated, the term “layer” can refer to a layer formed by a single coating or by multiple coatings of the same or different material. Moreover, the layers, other than the printed image layer, can be formed by any suitable coating or layering method including, but not limited to, spray coating, dip coating, bar coating, brush coating, spin coating, air knife coating, gravure coating, gap coating, roll coating, silk screen coating, extrusion coating, or any other suitable technique for forming the layer.

One component of the image transfer sheet is the sacrificial layer that can be relatively easily released from a backing sheet and can be removed (for example, solvated or released from the other layers) using a solvent, such as water, leaving the image intact on the receiving object. It may also functions as the receiving medium for the image or as the supporting layer for other functional layers. Preferably, the materials used to construct the sacrificial layer are substantially soluble in a solvent that does not cause substantial dissolution or degradation of the image.

In the embodiments described below, similar layers are given the same reference number among the different embodiments. It will be understood that, unless indicated otherwise, a description regarding a particular layer in one embodiment is generally applicable to the like-numbered layers in other embodiments.

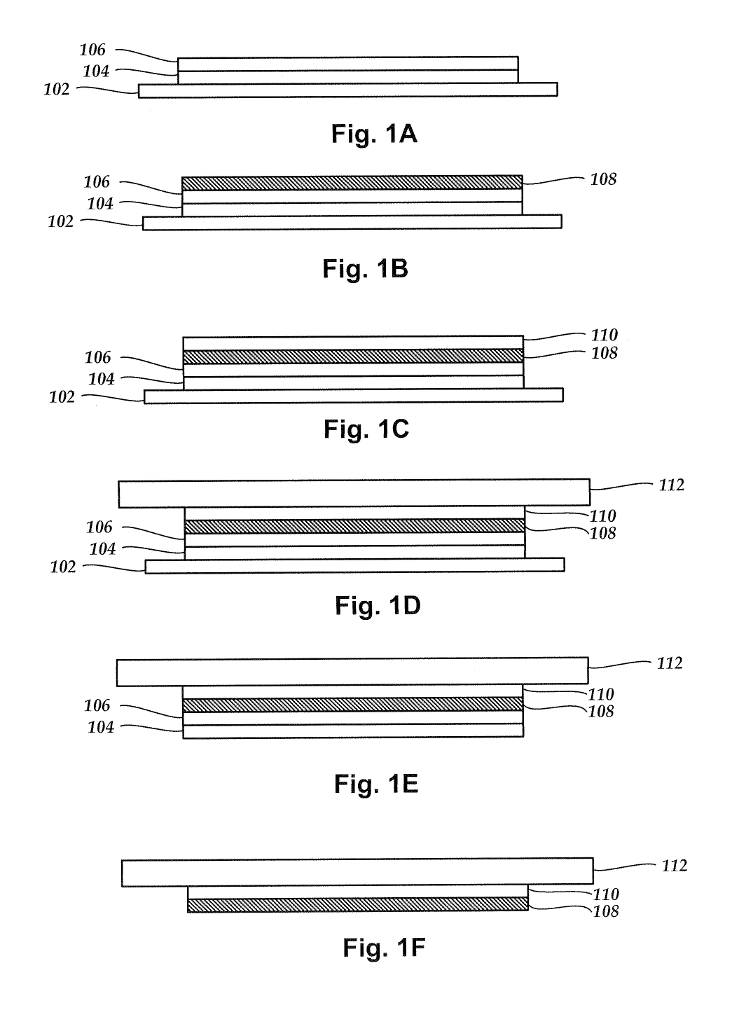

FIGS. 1A-1F illustrate one embodiment of a method of transferring an image to a receiving object. FIG. 1A illustrates a backing sheet 102, a water-releasable sacrificial layer 104, and an intermediate layer 106. Typically, the water-releasable sacrificial layer 104 and intermediate layer 106 are formed sequentially on the backing sheet 102.

The backing sheet 102 can be formed using any suitable polymer film or other substrate that can be separated from the sacrificial layer 104 relatively cleanly when desired. For example, the backing sheet can be made of polyethylene terephthalate (PET). Polymers (or combinations of polymers) other than PET can also be used as the backing sheet, such as polyesters, polyamides, polyacrylates, and polymethacrylates. The backing sheet should be compatible with the printing process (e.g., laser printing, LED printing, or dye-sublimation printing) used to print the image and be convenient to separate from the sacrificial layer 104. The thickness of the backing sheet 102 can be any suitable value such as, for example, in the range of 50 to 500 micrometers or in the range of 75 to 200 micrometers. It will be understood that the backing sheet may include any conventional film additives.

The sacrificial layer 104 is preferably water-releasable and, at least in some instances, water soluble. In some embodiments, the sacrificial layer may be releasable or soluble in another solvent in addition to, or as alternative to, water. The choice of materials for the sacrificial layer can take into account several factors such as the material of the backing sheet, the method for printing the image, the solvent that is to be used to remove the sacrificial layer, film-forming properties, and safety. Any suitable polymer or combination of polymers can be used including, but not limited to, polyvinyl alcohol (PVA) or PVA crosslinked using glyoxal, borate, heat, or the like.

The sacrificial layer 104 may be formed using a single coating or multiple coatings of the same or different material onto the backing sheet 102. In the case where the sacrificial layer is composed of multiple coatings of polymers, the subsequent coatings should not disrupt the existing coatings.

The sacrificial layer 104 may serve as a temporary medium to receive the image-forming materials (for example, toners or inks) or the support for an intermediate or functional layer as described herein. Accordingly, the sacrificial layer 104 is selected to endure the printing process to be used to form the image. For example, the sacrificial layer should resist melting during the fusing step of a laser or LED printing process. After the image has been transferred to a desired surface, it can be conveniently separated from the backing sheet and then removed through solvent treatment without affecting the quality of the transferred image.

An optional intermediate layer 106 can be formed on the sacrificial layer 104. The intermediate layer 106 can be formed by a single coating or multiple coatings of the same or different material. Preferably, the intermediate layer 106 can be coated using a solvent that does not solvate the sacrificial layer 104. In some embodiments, the intermediate layer 106 is soluble or releasable using a same solvent (e.g., water) as the sacrificial layer 104 to permit removal of the intermediate layer 106 with the sacrificial layer 104 at a later stage of the transfer process.

Any suitable polymer (or combination of polymers) can be used including, but not limited to, polyvinylpyrrolidone (PVP), polymethylmethacrylate (PMMA), polyacrylamide, poly(ethylene oxide), and poly(2-ethyl-2-oxazoline).

One example of an embodiment uses a PET backing layer, a PVA sacrificial layer, and a PVP intermediate layer. Because PVA does not have strong adhesion to some plastics such as PET, which enables convenient separation between the two films, a thin film of PVA from a PVA solution can be deposited on PET to serve as the sacrificial layer for the image transfer sheet. In at least some embodiments, it is preferred that PVA has a hydrolyzed content ranging from 80% to 100%. The thickness of the PVA layer can be any suitable value including a thickness in the range from 5 micrometers to 500 micrometers or in the range from 10 micrometers to 100 micrometers.

Because cross linkage can take place when PVA undergoes a heat treatment, such as during a laser or LED printing process to fuse the toner particles; another polymer such as PVP, which does not crosslink substantially by heat treatment, can be applied on the PVA layer as an intermediate layer and can optionally be used to receive the toners in laser or LED printing or the dyes in dye-sublimation printing. Both PVA and PVP polymers are soluble in water; however, their solubility in organic solvents is substantially different. After the PVA layer is dry, a solution of PVP in an organic solvent such as isopropanol, which is not a good solvent for PVA, can be applied onto the surface of the PVA layer using, for example, a film coater. Because PVA is not substantially soluble in isopropanol, PVP can form a uniform thin film on the PVA thin film without causing significant damage to the PVA layer underneath. The intermediate layer can have any suitable thickness including a thickness in the range from 5 micrometers to 500 micrometers or in the range from 10 to 50 micrometers.

In FIG. 1B, a printed image layer 108 is formed on the intermediate layer 106. The printed image layer 108 is formed by laser printing, LED printing, dye-sublimation printing, or any other suitable printing process. The printed image layer 108 includes toner, ink, or any other printing material. Although the printed image layer 108 in

FIG. 1B appears continuous, it will be recognized that this is not necessary and that the printed image layer 108 may be discontinuous and may include gaps. The printed image layer 108 may also impinge on or partially merge with the intermediate layer 106. For example, the toner, ink, or other printing material may be at least partially absorbed or otherwise at least partially encroaching into the intermediate layer during or after the printing process. Optionally, the printed image does not cover the entire area of a sheet containing the other layers and so the printed image can be cut out of the sheet before, or after, application of an adhesive layer (see below).

In FIG. 1C, an adhesive layer 110 is disposed over the printed image layer 108. The adhesive layer is for bonding the printed image layer to a receiving object.

As a result, the choice of the adhesive is at least partially dependent on the nature of the receiving object and how the receiving object is to be used. For instance, water soluble adhesive should not be chosen if the image is transferred to a garment, which often undergoes many washing and drying operations during its use. Spray adhesive, liquid adhesive, or any other suitable adhesive formulation can be used. Optionally, a second backing sheet (not shown) can be placed over the adhesive layer, particularly, if the image is to be transferred to a receiving object much later.

The adhesive can be reactive or non-reactive. For applications that do not involve bending or movement of the image, a cross-linkable adhesive (epoxy adhesives, reactive polyurethanes, and the like) may be preferred, especially when the image is to be transferred to a hard surface such as, for example, a ceramic mug.

The adhesive layer preferably completely covers the whole surface of the printed image layer. The adhesive layer can have any suitable thickness including a thickness in the range of 5 micrometers to 200 micrometers or in the range from 10 to 50 micrometers.

The image transfer sheet is attached to a receiving object 112, as illustrated in FIG. 1D. If a second backing sheet was applied over the adhesive layer 110, then the second backing sheet is removed prior to attachment to the receiving object 112. Any suitable receiving object can be used including receiving objects made from cloth, fabric, leather, plastic, ceramic, metal, wood, paper, fingernail, and the like. The adhesive layer 110 binds the image transfer sheet to the receiving object 112. Preferably, the adhesive layer 110 permanently binds the printed image layer 108 directly or indirectly to the receiving object 112.

The attachment of the image transfer sheet to the receiving object is preferably performed non-thermally (e.g., without the application of substantial heat for the transfer). It will be understood that such non-thermal transfer may include application of some heat after the attachment to dry the adhesive, but such heating is not generally required.

After sufficient bonding strength between the adhesive layer 110 and the receiving object has been achieved, the backing sheet 102 can be removed by carefully peeling it away from the sacrificial layer, as illustrated in FIG. 1E. The sacrificial layer 104 and, optionally, the intermediate layer 106 can then be removed as illustrated in FIG. 1F. The removal of the sacrificial layer 104 can be accomplished by rinsing the sacrificial layer with water or another applicable solvent. The rinsing time may depend on the sacrificial layer and the solvent and can be, for example, for a period ranging from 30 seconds to 1 minute or simply immersing it into water for up to 1 minute. If rinsing the image with water or other solvent is not permitted, the image can be wiped with a wet towel to remove the sacrificial layer. In at least some instances, the intermediate layer 106 is also removed using water or other solvent.

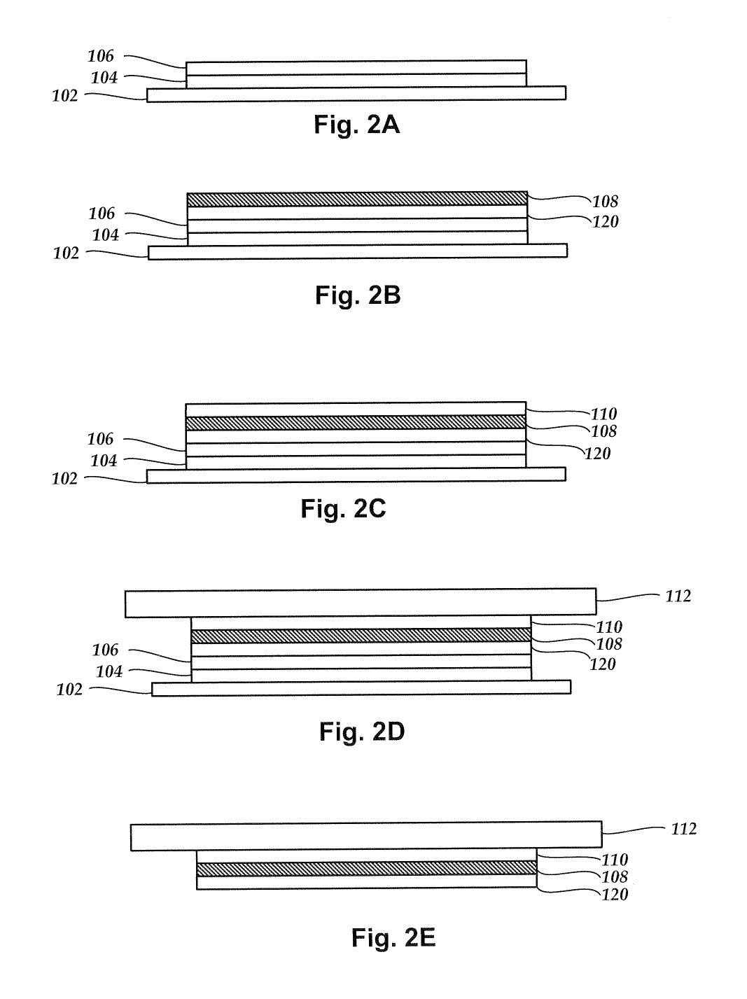

FIGS. 2A-2E illustrate another embodiment of a method of transferring an image to a receiving object. FIG. 2A illustrates a backing sheet 102, a water-releasable sacrificial layer 104, and an intermediate layer 106. In FIG. 2B, a functional layer 120 is formed on the intermediate layer 106 and then a printed image layer 108 is formed on the functional layer 120.

The functional layer 120 can be, for example, a protection layer to further enhance the quality of the final product. For example, the functional layer 120 can be a protection layer that covers the toner or ink of the image and not only protects the image from toner or ink loss and quality degradation, but also offers additional physical properties to improve or enhance the look and feel of the image. For example, a protection layer may be water resistant to protect the underlying image from water. This may be particularly useful for images transferred to garments which will be subjected periodically to washing.

The functional layer may include one or multiple coatings of polymers, depending on the application. It will be also understood that a transfer sheet can include more than one functional layer, particularly if each layer has a different function (e.g., a protection layer and a flexible layer).

Additionally or alternatively, the functional layer 120 can give the image certain physical attributes such as flexibility, glossy finish, matte finish, and so forth. Film-forming products such as spray finishes and lacquers, polymers such as polymethylmethacrylate (PMMA), polystyrene (PS), polyurethanes (PU), polyesters (PE), and their copolymers or block polymers can be used to form the functional layer, depending on the applications of the end products and the materials of the other layers. The functional layer can have any suitable thickness including a thickness in the range from 5 micrometers to 1000 micrometers or in the range between 10 to 100 micrometers.

In some embodiments, a flexible functional layer is used. This may be particularly useful when the image is to be transferred onto a garment that will be stretched, folded, and so forth. Materials for a flexible functional layer can include, for example, a polymer such as polymethylmethacrylate (PMMA) containing a plasticizer or a proper copolymer or block polymer may be selected. When a plasticizer is used, its amount can range from, for example, 1% to 50% by weight in solid film state, preferably from 10% to 30% by weight. For PMMA, dibutyl phthalate (DBP) and dioctyl terephthalate (DOTP) are examples of suitable plasticizers. Alternatively or additionally, polymers having long hydrocarbon siding chains such poly(butyl methacrylate) or poly(hexyl methacrylate) can also be used to form a flexible functional layer. Also particularly useful are block polymers that has alternate rigid segments and flexible segments polymer backbone, such as polystyrene-block-polybutadiene-block-polystyrene, polystyrene-block-polyisopreneblock-polystyrene, and polystyrene-block-poly(ethylene-ran-butylene)-block-polystyrene. The content of polystyrene in these block polymers can range from, for example, 5% to 50% or from 10% to 30%. In at least some embodiments, these block polymers can be dissolved into an organic solvent such as toluene and coated onto the sacrificial layer or the intermediate layer. Since these block polymers are often tacky and easy to melt, an optional separation layer of plasticized PMMA may be desirable over the flexible functional layer so that the transfer sheet does not stick to any printer elements during the printing process, preventing jamming or damage to the printer. The separation layer can have any suitable thickness, for example, a thickness ranging from 5 micrometers to 500 micrometers or from 10 micrometers to 50 micrometers.

Additionally or alternatively, the functional layer 120 can protect the image from ultraviolet (UV) light, which can cause degradation of the image. In this case, UV-absorbing inorganic compounds (for example, nano-sized titanium dioxide or zinc oxide) or UV-absorbing organic compounds (for example, benzophenones) can be incorporated into the protection layer through dissolution or dispersion of these UV-absorbing compounds in a suitable medium for coating. This UV protection layer can effectively absorb UV light while maintaining visibly colorless and clear.

The printed image layer 108 is formed over the functional layer. An adhesive layer 110 is formed over the printed image layer 108, as illustrated in FIG. 2C, and the image transfer sheet is then applied to a receiving object 112, as illustrated in FIG. 2D. The backing sheet 102, water-releasable layer 104, and optional intermediate layer 106 can be removed, as illustrated in FIG. 2E.

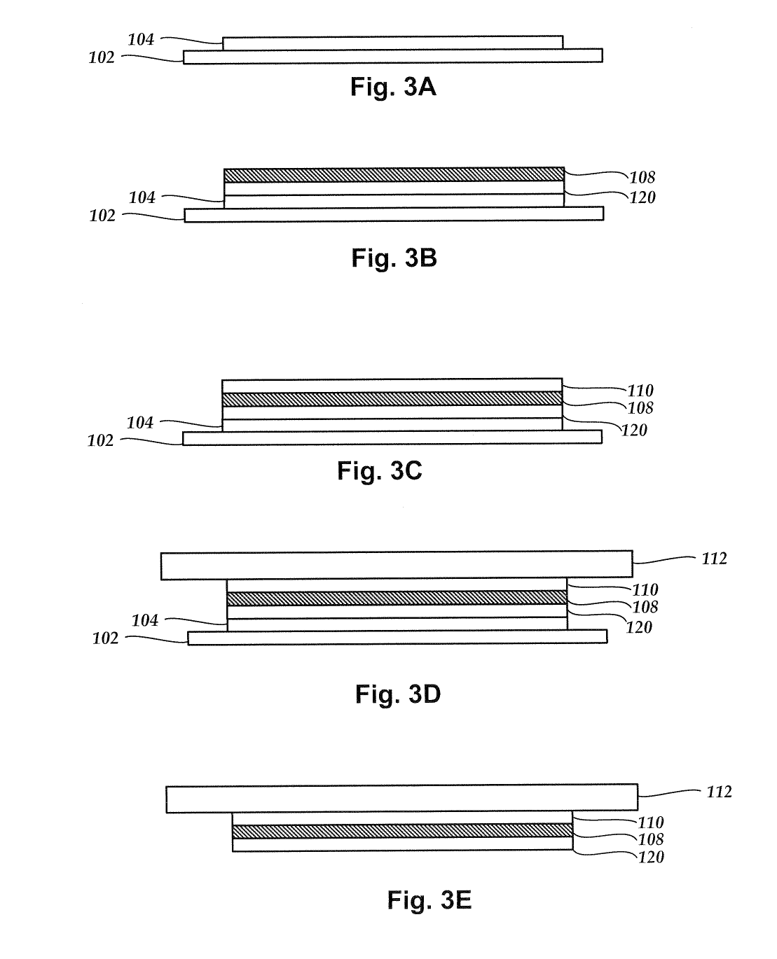

FIGS. 3A-3E illustrate another embodiment, similar to the embodiment of FIGS. 2A-2E, except that there is no intermediate layer. Instead, the functional layer 120 (or functional layers) is formed directly on the sacrificial layer 104.

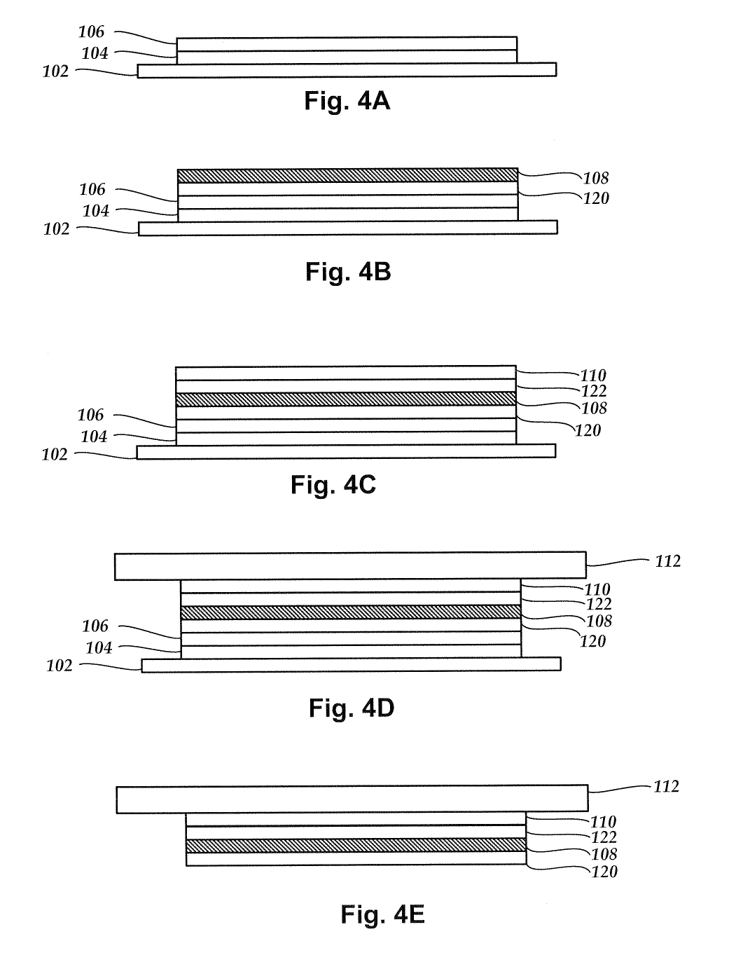

FIGS. 4A-4E illustrate a further embodiment in which a second functional layer 122 is formed over the printed image layer 108, as illustrated in FIG. 4C. The adhesive layer 110 is disposed over the second functional layer 122. The second functional layer 122 may be any of the layers described above with respect to functional layer 120. For example, the second functional layer 122 may be a protection layer that protects the printed image layer 108. The second functional layer 122 may be water-resistant to protect the printed image layer 108 from water (for example, if the receiving object 112 is a garment that will be washed repeatedly which may damage the printed image layer). The second functional layer 122 may be a flexible layer to provide flexibility for the transferred image (for example, for a garment that will be folded creased, stretched, and the like.)

It will be understood that variations on this embodiment can be made. For example, particular embodiments may omit the functional layer 120, the intermediate layer 106, or both.

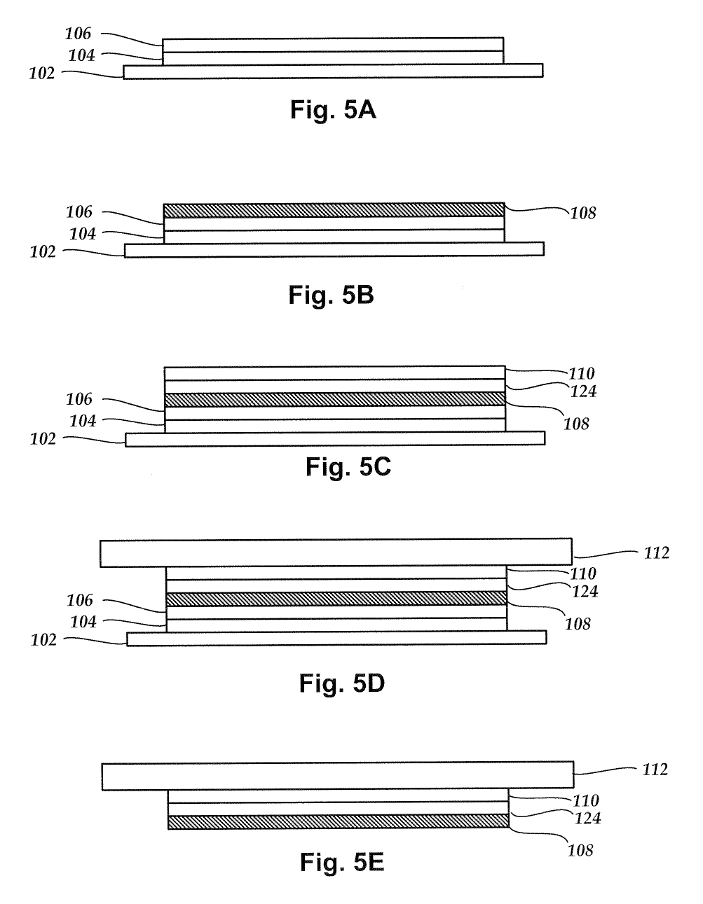

FIGS. 5A-5E illustrate another embodiment of a method of transferring an image to a receiving object. FIG. 5A illustrates a backing sheet 102, a water-releasable sacrificial layer 104, and an intermediate layer 106. In FIG. 5B, a printed image layer 108 is formed on the intermediate layer 106.

In FIG. 5C, a background color layer 124 is formed over the printed image layer 108. The background color layer 124 provides color in the gaps and discontinuities of the printed image layer 108. The background color layer can be any color. White is a particularly useful color, especially if the receiving object is not white. For example, if the receiving object is black or a non-white color, a white background layer is used to shield the image from the colors of the object. A white background layer can be formed using, for example, white spray paints, oil-based white paints, or water-based white paints. The thickness of the white background layer may be such that the underneath image cannot be seen through the white background layer. The background color layer can be any suitable thickness including, for example, a thickness in the range of 5 micrometers to 500 micrometers or in the range of 10 to 30 micrometers.

An adhesive layer 110 is formed over the background color layer, as illustrated in FIG. 5C, and the image transfer sheet is then applied to a receiving object 112, as illustrated in FIG. 5D. The backing sheet 102, sacrificial layer 104, and optional intermediate layer 106 are removed as illustrated in FIG. 5E.

It will be understood that variations on this embodiment can be made. For example, another embodiment may add a functional layer between the sacrificial layer and the printed image layer or a second functional layer between the background color layer and the adhesive layer or both functional layers. Embodiments may also omit the intermediate layer.

As an alternative to, or in addition to, providing a functional layer that produces a matte finish, the sacrificial layer 104, intermediate layer 106, or functional layer 120 (or any combination of these layers) may be roughened so that subsequently formed layers (and, in particular, the subsequently formed printed image layer) have a roughened surface resulting in a matte finish to the printed image layer. For example, the sacrificial layer 104, intermediate layer 106, or functional layer 120 might be treated with a substance (e.g., an acid or a liquid that partially solvates, pits, or otherwise roughens the layer) which removes portions of the layer in a non-uniform manner. As another example, if the functional layer is PMMA, an organic solvent, such as methyl ethyl ketone, ethyl acetate, or acetone, can be carefully sprayed over the coating to form “micro-craters” on the surface of PMMA. If no function layer 120 and intermediate layer 106 is used, a glycol ether, such as diethylene glycol ethyl ether, can be sprayed onto the sacrificial layer 104 to roughen the surface of that layer.

Although the individual components for making the coatings might be provided to a consumer in a kit, the image transfer sheet could be provided to the consumer in a complete (e.g., containing all of the layers and ready to attach to the receiving object) or a partial form. In the complete form, the printed image layer 108 already includes the image to be transferred. Optionally, this image transfer sheet includes a second backing sheet over the adhesive layer 110. The second backing sheet can then be removed and the image transfer sheet applied to the receiving object 112.

A variety of partial forms can also be provided. For example, a partial image transfer sheet may be provided that includes the backing sheet 102 and sacrificial layer 104 and optionally one or both of the optional intermediate layer 106 and the optional functional layer 120. This sheet is then ready for the consumer to form the printed image layer 108 and then apply the adhesive layer 110 (and optionally a second functional layer). The topmost layer of the image transfer sheet (e.g., the sacrificial layer, intermediate layer, or functional layer) acts as an image-receiving layer. The consumer selects a desired image and then places the partial image transfer sheet into a printer (e.g., a laser printer, LED printer, or dye-sublimation printer) to form the printed image layer 108 on the image receiving layer of the partial image transfer sheet. The consumer can then apply the adhesive and transfer the image to the receiving object as described above. In some embodiments, the consumer may also form one or more functional layer 122 after printing the image.

Another partial form includes the printed image layer already formed and only requires the addition of an adhesive layer. The consumer forms the adhesive layer and then transfers the image to the receiving object as described above. It will be recognized that other partial image transfer sheets can be provided. It will also be recognized that a partial image transfer sheet can be included in a kit with one or more items such as adhesive, paper, film (e.g., a backing sheet) toner, ink, or even a printer.

In some embodiments, the backing sheet 102, sacrificial layer 104, optional intermediate layer 106, and optional functional layer 120 may be attached to a paper or film to facilitate printing of the printed image layer 108 using a printer. The paper or film can act as a carrier to carry the layers through the printer and the paper or film can be later removed prior to or after transferring the image to the receiving object.

### EXAMPLES

### Example 1

### Transfer of a Laser-Printed Image to White Weave

A 6.7% polyvinyl alcohol (PVA) (99+% hydrolyzed, purchased from Aldrich) solution was coated on a piece of filled, white poly(ethylene terephthalate) (PET) sheet using a Elcometer 4340 Motorized Automatic Film Applicator (Elcometer Inc., Rochester Hills, Mich.). The coating parameters were 200 micrometers in height setting and 20 in speed setting. After drying under ambient conditions for about 60 minutes a clear and smooth PVA thin coating was obtained.

A 6.5% isopropanol solution of polyvinylpyrrolidone (PVP, Sigma-Aldrich, Milwaukee, Wis.) was coated onto the PVA coating using the Elcometer 4340 at settings of 100 micrometers in height and 20 in speed. It was dried under ambient conditions for about 40 minutes to yield a clear coating.

An image was printed onto the PVP layer using a Brother HL-4040CN laser printer. The image was then cut out of the printout sheet along the image border with a pair of scissors. To the surface of the image a spray adhesive was applied (Elmer's Spray Adhesive, Elmer's Products Inc., Columbus, Ohio). Immediately a piece of white weave (65% polyester, 35% cotton, from JoAnn Fabrics) was laid on the adhesive layer and pressed firmly against the image. The adhesive was allowed to set for 3 hours under ambient conditions.

After the adhesive had completely set, the PET sheet was carefully peeled off from the white weave, leaving behind the PVA and PVP layers covering the image. The weave was then immersed into water for about 1 minute, which caused the PVA and PVP layers to come off from the image through gentle agitation of the water. After drying under ambient conditions, the image appeared brightly and vividly colored.

### Example 2

### Transfer of a Laser-Printed Image to a Black Cotton T-Shirt

A 6.7% PVA solution was coated onto a sheet of PET on the Elcometer 4340 at settings of 200 micrometers in height and 20 in speed. A clear and smooth PVA coating was obtained after drying under ambient conditions for 1 hour. Upon the PVA coating a 6.5% PVP isopropanol solution was coated using the Elcometer 4340 at settings of 100 micrometers in height and 20 in speed. The coating was allowed to dry under ambient conditions for 1 hour.

The resulting sheet was attached to a piece of printer paper and fed into a Brother HL-4040CN laser printer. An image was printed onto the surface of the PVP layer. The image was cut out along the perimeter of the image. It was then sprayed with

Krylon Fusion 2320 White Paint (Krylon Products Group, Cleveland, Ohio) over the image until the image was completely covered by a coat of white paint. The white paint was dried under ambient conditions for 2 hours.

The image sheet was then uniformly sprayed with Elmer's Spray Adhesive across the white paint, it was firmly pressed against a Hanes black cotton T-shirt for 1 minute and then dried under ambient conditions for 2 hours. The PET sheet was carefully peeled away to expose the PVA layer. After gently rinsing with water for about 30 seconds, the PVA and PVP layers came off the image. The resulting T-shirt with the transferred image was dried under ambient conditions.

### Example 3

### Transfer of a Laser-Printed Image to the Outer Wall of a Ceramic Mug

A 6.7% PVA solution was coated onto a PET sheet on the Elcometer 4340 at settings of 200 micrometers in height and 20 in speed. After drying under ambient conditions for 1 hour, a clear and smooth PVA coating was obtained. A 6.5% PVP isopropanol solution was subsequently coated onto the PVA coating using the Elcometer 4340 at settings of 100 micrometers in height and 20 in speed and dried for 1 hour.

The sheet was first attached to a piece of printer paper and then fed into a Brother HL-4040CN laser printer, on which an image was printed onto the PVP layer. The image was cut out of the sheet using a pair of scissors. After spraying with Elmer's

Spray Adhesive over the image cutout, it was allowed to dry under ambient conditions for 15 minutes before it was attached to the outer wall of a white ceramic mug. The PET sheet was carefully peeled off from the sacrificial coating and the mug was further dried under ambient conditions for another 2 hours. The PVA and PVP layers were removed by exposure to gentle running tap water for about 1 minute.

### Example 4

### Transfer of a Laser-Printed Image on a White Weave

A solution of 6.7% PVA (99+% hydrolyzed) was coated on a white PET sheet using the Elcometer 4340 Motorized Automatic Film Applicator. The coating parameters were 200 micrometers in height and 20 in speed setting. The PVA coating was dried for 60 minutes before further handling. A 6.5% isopropanol solution of PVP (Aldrich) was subsequently coated onto the PVA coating on the Elcometer 4340 at settings of 100 micrometers in height and 20 in speed. The PVP coating was dried under ambient conditions for about one hour.

A functional layer was formed on the PVP layer by spraying on one pass Krylon Low Odor Clear Finish (Gloss) (Krylon Products Group, Cleveland, Ohio) to cover the area of the sacrificial coating. It was then dried under ambient conditions for 2.5 hours. The resulting sheet was attached to a piece of printer paper (8.5 inch×11 inch) with the coating side facing up such that an image can be printed onto the functional layer. After the paper was fed into a Brother HL-4040CN laser printer, an image was printed onto the functional layer.

The image was cut out from the printed sheet along the image border. The cutout was sprayed with Elmer's Spray Adhesive and immediately attached to a piece of white weave (JoAnn Fabrics). The adhesive was allowed to set for 3 hours under ambient conditions.

After the adhesive had completely set, the PET sheet was carefully peeled off from the transferred image. The article was then immersed into water for 1 minute to remove the PVA and PVP coatings. The resultant article was dried under ambient conditions.

### Example 5

### Transfer of a Laser-Printed Image on PMMA Coating to a White Weave

A solution of 6.7% PVA (99+% hydrolyzed) was coated on a PET sheet using the Elcometer 4340 at settings of 200 micrometers in height and 20 in speed. It was dried under ambient conditions for 1 hour. An acetone solution of 10% poly(methyl methacrylate) (PMMA) (Sigma-Aldrich, Milwaukee, Wis.) was coated on the PVA layer using the Elcometer 4340 at settings of 200 micrometers in height and 20 in speed. It was then dried under ambient conditions for 30 minutes.

The resultant PET sheet was fed into a Brother HL-4040CN Laser Printer to print an image on the PMMA layer. The image was cut out along the perimeter and was sprayed with Elmer's Spray Adhesive over the image area. It was immediately attached to a piece of JoAnn white weave and allowed to set for 3 hours.

The PET sheet was carefully peeled away from the image to expose the PVA coating, which was then removed by rinsing it with water for 30 seconds. The resultant article was dried under ambient conditions.

### Example 6

### Transfer of a Laser-Printed Image on Plasticized PMMA Coating to a White Weave

A solution of 6.7% PVA was coated on a PET sheet using the Elcometer 4340 at settings of 200 micrometers in height and 20 in speed. It was dried under ambient conditions for 1 hour. A solution of 10% PMMA in acetone containing 1.5% dibutyl phthalate (DBP) (Sigma-Aldrich, Milwaukee, Wis.) was coated on the PVA layer using the Elcometer 4340 at settings of 200 micrometers in height and 20 in speed. It was dried for 30 minutes under ambient conditions.

An image was printed onto the PMMA-DBP layer using a Brother HL-4040CN laser printer. The image was then cut out of the sheet along the perimeter of the image using a pair of scissors. A thin layer of Loctite Spray Adhesive (Henkel Corporation, LaGrange, Ga.) was applied over the image. After drying under ambient conditions for 2 minutes, the image was firmly pressed against a piece of JoAnn white weave and then allowed to set for another 2 hours.

The PET sheet was carefully bent at a corner and peeled off from the image. The exposed PVA layer was removed by rinsing it with water for 1 minute. The resultant article was dried under ambient conditions until it was dry.

### Example 7

### Transfer of a Laser Printed Image on Plasticized PMMA Coating to a White Cotton T-Shirt

A solution of 6.7% PVA (99+% hydrolyzed) was coated on a PET sheet using the Elcometer 4340 at settings of 200 micrometers in height and 20 micrometers in speed. It was then dried under ambient conditions for 1 hour. A solution of 10% PMMA in acetone containing 1.5% DBP was coated on the PVA layer using the Elcometer 4340 at settings of 200 micrometers in height and 20 in speed. It was dried for 30 minutes under ambient conditions.

An image was printed on the PMMA-DBP layer using a Brother HL-4040CN laser printer. After it was cut out of the sheet using a pair of scissors, the image was sprayed with Loctite Spray Adhesive. The adhesive was first allowed to set for 3 minutes before it was firmly pressed against a Hanes white cotton T-shirt. The adhesive continued to set under ambient conditions for another 3 hours.

The PET sheet was peeled off by slightly bending a corner of the image and the remaining PVA layer was washed off by rinsing the image with water for 1 minute. The resulting article was dried under ambient conditions.

### Example 8

### Transfer of a Laser Printed Image on Plasticized PMMA Coating to a Black Cotton T-Shirt

A 6.7% PVA (99+% hydrolyzed) was coated on a PET sheet using the Elcometer 4340 at settings of 200 micrometers in height and 20 in speed. The coating was dried for 1 hour under ambient conditions. A 10% PMMA solution in acetone containing 1.5% DBP was coated on the PVP layer using the Elcometer 4340 at settings of 200 micrometers in height and 20 in speed. The coating was dried under ambient conditions for 30 minutes.

An image was printed on the PMMA-DBP layer using a Brother HL-4040CN laser printer, and the resulting image was cut out using a pair of scissors. Over the image a white coating was formed by spraying Krylon Fusion White Paint. It was dried under ambient conditions for 2 hours.

The water-based adhesive, API's The Ultimate! Glue (The Adhesive Products Inc., Albany, Calif.) was applied over the image cutout. It was then attached to a Hanes black cotton T-shirt and the adhesive was allowed to set for 3 hours. The PET sheet was peeled away from the image by slightly bending the corner of the image and the exposed PVA layer was removed by rinsing it with water for 1 minute. The resulting T-shirt was dried under ambient conditions.

### Example 9

### Transfer of a Laser-Printed Nail Art Image Using a Rubbery Adhesive Polybutene

A 6.7% PVA (99+% hydrolyzed) was coated on a PET sheet using the Elcometer 4340 at settings of 200 micrometers in height and 20 in speed. It was dried under ambient conditions for 1 hour. A 6.5% PVP solution in isopropanol was coated on the PVA layer using the Elcometer 4340 at settings of 100 micrometers in height and 20 in speed. It was dried for 30 minutes under ambient conditions.

A thin layer of lacquer was formed by spraying Rust-Oleum Specialty Lacquer (Rust-Oleum, Vernon Hills, Ill.) over the PVP layer. It was dried for 18 hours under ambient conditions. A thin layer of clear finish was formed on the lacquer layer by spraying Krylon Low Odor Clear Finish (Krylon Products Group, Cleveland, Ohio) over the lacquer layer. It was dried for 4 hours under ambient conditions.

An image was printed on the clear finish layer using a Brother HL-4040CN laser printer. After the image was cut out, five drops of 3.8% polybutene solution in cyclohexane (Sigma-Aldrich, Milwaukee, Wis.) was dripped onto the image and spread over the entire image surface. After the cyclohexane was evaporated, the image was attached to a piece of PET sheet by pressing it down firmly on the PET sheet.

The PET backing sheet was peeled off by slightly bending the edge of the image to expose the PVA layer on the image. The removal of the PVA layer was achieved by rinsing it with water for 1 minute.

### Example 10

### Transfer of a Laser-Printed Image on a Rubbery Coating to White T-Shirt

A 6.7% PVA (99+% hydrolyzed) solution was coated on a PET sheet using the Elcometer 4340 at settings of 200 micrometers in height and 20 in speed. The resulting coating was dried under ambient conditions for 1 hour. A 20% solution of polystyrene-block-polybutadiene-block-polystyrene (PS-b-PB-b-PS) (Sigma-Aldrich, Milwaukee, Wis.) in toluene was coated on the PVA layer using the Elcometer 4340 at settings of 400 micrometers in height and 20 in speed. It was dried under ambient conditions for 1 hour.

A PMMA layer was subsequently formed by coating an acetone solution of 8.5% PMMA and 1.5% DOTP (Sigma-Aldrich, Milwaukee, Wis.) on the PS-b-PB-b-PS layer using the Elcometer 4340 at settings of 200 in height and 20 in speed. It was dried for 30 minutes under ambient conditions.

An image was printed on the PMMA-DOTP layer using a Brother HL-4040CN laser printer, and the resulting image was cut out using a pair of scissors. Liquid Stitch (Prym Consumer USA Inc., Spartanburg, S.C.) was spread across the whole image area and the image was immediately attached to a Hanes white cotton T-shirt. After the adhesive was allowed to set for 3 hours, the PET sheet was peeled away. The PVA layer was removed by rinsing it with water for 1 minute. The resulting T-shirt was dried under ambient conditions.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A multilayer image transfer sheet for non-thermally transferring an image to a receiving object, comprising, in the following order with respect to each other:
a backing sheet;
a water-releasable sacrificial layer disposed on the backing sheet;
a printed image layer disposed over the water-releasable sacrificial layer, wherein the printed image layer comprises toner or dye printed using a laser printer, LED printer, or dye-sublimation printer to form at least one image; and
an adhesive layer disposed over the printed image layer and configured and arranged for permanent attachment of the printed image layer to a receiving object.

2. The image transfer sheet of claim 1, further comprising an intermediate layer disposed between the water-releasable sacrificial layer and the printed image layer.

3. The image transfer sheet of claim 2, wherein the intermediate layer is water-releasable.

4. The image transfer sheet of claim 1, wherein the adhesive layer is configured and arranged for non-thermal permanent attachment of the printed image layer to the receiving object.

5. The image transfer sheet of claim 1, further comprising a protective layer formed between the printed image layer and the adhesive layer, the protective layer being water-resistant.

6. The image transfer sheet of claim 1, further comprising a protective layer fowled between the printed image layer and the water-releasable sacrificial layer, the protective layer being water-resistant.

7. The image transfer sheet of claim 1, further comprising a background color layer formed between the printed image layer and the adhesive layer.

8. The image transfer sheet of claim 1, wherein the water-releasable sacrificial layer comprises polyvinyl alcohol.

9. The image transfer sheet of claim 1, wherein the backing sheet comprise polyethylene terephthalate.

10. The image transfer sheet of claim 1, further comprising a second backing sheet disposed over the adhesive layer.

11. The image transfer sheet of claim 1, further comprising a flexible functional layer formed between the printed image layer and the water-releasable sacrificial layer.

12. The image transfer sheet of claim 1, wherein the printed image layer comprises toner laser printed or LED printed to form the at least one image.

13. A method of making a multilayer image transfer sheet, the method comprising:
forming a water-releasable sacrificial layer on a backing sheet;
printing an image layer over the water-releasable sacrificial layer using a laser printer, LED printer, or dye-sublimation printer; and
disposing an adhesive layer over the image layer, wherein the adhesive layer is configured and arranged for permanent attachment of the printed image layer to a receiving object.

14. The method of claim 13, further comprising forming an intermediate layer on the water-releasable sacrificial layer.

15. The method of claim 13, further comprising forming a protective layer between the printed image layer and the adhesive layer, the protective layer being water-resistant.

16. The method of claim 13, further comprising forming a protective layer between the printed image layer and the water-releasable sacrificial layer, the protective layer being water-resistant.

17. A sheet for non-thermally transferring an image to a receiving object, comprising, in the following order with respect to each other:
a backing sheet;
a water-releasable sacrificial layer disposed on the release liner; and
an image receiving layer configured and arranged to receive an image printed using a laser printer, LED printer, or dye-sublimation printer onto the image receiving layer.

18. The sheet of claim 17, wherein the image receiving layer comprises an intermediate layer disposed on the water-releasable sacrificial layer.

19. The sheet of claim 17, wherein the image receiving layer comprises a protective layer disposed over the water-releasable sacrificial layer.

20. The sheet of claim 19, further comprising a water-releasable intermediate layer disposed between the protective layer and the water-releasable sacrificial layer.

21. A kit for non-thermally transferring an image to a receiving object, comprising:
the sheet of claim 17; and
adhesive configured and arranged for application over an image printed on the image receiving layer and for permanent attachment of the sheet and image to a receiving object.

22. A method for non-thermal transfer of an image onto an article, the method comprising:
providing the multilayer image transfer sheet of claim 1;
permanently attaching the multilayer image transfer sheet to the article using the adhesive layer;
removing the backing sheet; and
removing the water-releasable sacrificial layer by exposure to water.
